(19) United States
(12) Patent Application Publication
(10) Pub. No.: US 2016/0170606 A1
(43) Pub. Date: Jun. 16, 2016

(54) CUSTOMIZED SEARCH ICON OUTPUT CONTROL SYSTEM AND METHOD THEREFOR

(71) Applicant: TW MOBILE CO., LTD, Seocho, Seoul (KR)

(72) Inventors: Se-yong Lee, Seoul (KR); Kyo-sik Hong, Ansung (KR)

(21) Appl. No.: 14/908,284

(22) PCT Filed: Jul. 14, 2014
(86) PCT No.: PCT/KR2014/006292

§ 371 Date: Jan. 28, 2016

(30) Foreign Application Priority Data
Jul. 31, 2013 (KR) 10-2013-0091054

(51) Int. Cl. G06F 3/0481; G06F 3/0482; G06F 17/30; G06F 3/0484

(52) U.S. Cl. CPC G06F 3/04817; G06F 3/04842; G06F 3/0482; G06F 3/04845; G06F 17/30864

(57) ABSTRACT

The present invention relates to a customized search icon output control system and a method thereof. An object of the present invention is to provide a customized search icon output control system and a method thereof which are capable of inputting a single search word and sequentially selecting search icons several times to guide a search word selection, to thereby allow a user who has difficulty in selecting proper search words and a user who tries an Internet search while walking to very conveniently use the search word, and breaking a connection with a search server while the user selects a search icon using search icon packs downloaded for each search word, to thereby remarkably reduce access traffic.

### TECHNICAL FIELD

The present invention relates to a customized search icon output control system and a method thereof, and more particularly, to a customized search icon output control system and a method thereof which are capable of inputting a single search word and sequentially selecting search icons several times to guide a search word selection, to thereby allow a user who has difficulty in selecting proper search words and a user who tries an Internet search while walking to very conveniently use the search word, and breaking a connection with a search server while the user selects a search icon using search icon packs downloaded for each search word, to thereby remarkably reduce access traffic.

### BACKGROUND ART

As known in the art, the Internet system is constructed as a system for opening various types of information to allow unspecified users to read the information, expansively reproduce the information, and verify the information themselves. The information is very enormous and therefore the time taken to search specific information is getting longer and longer over time.

In particular, younger generations who do the Internet search all the time may search various types of information without difficulty, but other generations have great difficulties in doing the Internet search itself or require a lot more search time than other users and therefore waste a lot of time.

The Internet search is based on a keyword search method for allowing users to independently think up proper keywords for searching specific information and input them. However, users who are unfamiliar with the Internet search cannot think up proper search words required for information search.

Recently, as personal digital assistants such as a smart phone and a portable PC are becoming popular, the Internet search environment is getting better and the Internet upload is more increased proportionately. As a result, the Internet information is more enormous.

However, Internet search portal servers have excessively concentrated access traffic, and therefore systems may be down unless server capacity is continuously increased.

However, in order to find out proper keywords or search products to which users' tastes are appropriately reflected in most of the Internet searches, searches within searched results are repeated several times. The access traffic may also be generated continuously in the search structure.

Further, users using the personal digital assistants such as the smart phone and the portable PC have difficulties in directly inputting search words using a keyboard while walking and have frequent typos, and as a result the users repeat a process of deleting the search words and then inputting them again to waste unnecessary time.

### DISCLOSURE

### Technical Problem

In consideration of the above-mentioned circumstances, it is an object of the present invention to provide a customized search icon output control system and a method thereof which are capable of inputting a single search word and sequentially selecting search icons several times to guide a search word selection, to thereby allow a user who has difficulty in selecting proper search words and a user who tries an Internet search while walking to very conveniently use the search word and breaking a connection with a search server while the user selects a search icon using search icon packs downloaded for each search word, to thereby remarkably reduce access traffic.

### Technical Solution

In order to accomplish the above objects, according to one aspect of the present invention, there is provided a customized search icon output control system, including: a user terminal 2 which has applications embedded therein, and is configured to download search icon packs matched with search keywords input by a user from a customized search support server 20 and perform a search by sequentially selecting the search icon packs; and the customized search support server 20 configured to receive the search keywords from the user terminal 2 to extract the search icon pack matched with the search keywords, break a connection with the user terminal 2, receive search operation information including sequential selection information of the search icon pack from the user terminal 2 to drive a search engine, and transmit the search result to the user terminal 2.

Preferably, the search icon pack is stored in the customized search support server 20 to be matched with each search keyword, and includes first search icon groups 12a to be selected by the search keyword and second search icon groups 12b to be selected by the user among the first search icon groups 12a, which are search icon group information having a plurality of tree structures connected to each other.

Preferably, the search icon pack is stored in the user terminal 2, and the search icon is deleted by a selection of the user.

Preferably, the search icon pack deletes the search icon by a selection of the user and applications of the user terminal 2 automatically transmit the deleted information to the customized search support server 20.

Preferably, the search icon pack includes basic search icon packs matched with each search key word, and a final search icon pack which is selection reference information for a final search result regardless of the search keyword.

Preferably, the search icon pack includes standard search icon packs classified for each age and area and downloaded to be stored in the customized search support server 20.

Preferably, the search operation information is information including basic search icon selection information, final search selection information, and identification information of the user terminal.

Preferably, the user terminal 2 includes: a communication module 22 which communicates with the customized search support server 20; a search icon pack download unit 24 configured to receive the search icon pack matched with the search keyword input by the user from the customized search support server 20; search icon pack edition units 26 and 28 configured to allow the user to edit the search icon pack; a search icon display controller 30 which performs a control to display the final search icon on a screen or make the final search icon disappear from the screen by the selection of the user; a key input unit 34 configured to input the search key word and the selection signal of the search icon; a search operation information generation unit 40 configured to combine the sequential selection information of the search icon, final search icon selection information, and the identification information of the user terminal; search icon pack storage units 36 and 38 configured to store the search icon information; and a controller 42 configured to control each of the components to download the search icon pack including a plurality of search icons to generate the search operation information having sequential selection search icon information of the user and transmit the generated search operation information to the customized search support server 20.

Preferably, the customized search support server 20 includes: a communication module 44 which communicates with the user terminal 2; a keyword interworking search icon pack management unit 46 configured to match the search icon packs with each keyword to register and extract the search icon packs; a pack edition information storage unit 48 configured to receive and store a first search keyword and search icon pack edition information for each user from the user terminal 2; a search engine 50 configured to perform a search using the search keyword and the icon selection information; an application download management unit 52 configured to manage a search application to be downloaded to the user terminal 2; a search operation information processor 54 for each user configured to sequentially drive the search engine 50 using the sequential search icon information and the final search icon information included in the search operation information received from the user terminal 2; and a controller 56 configured to control each of the components to receive the sequentially selected search icon information from the user terminal 2 so as to drive the search engine.

Preferably, the final search icon pack is information including search icons using a short distance, a business of big discounts, or a business holding a large parking lot as contents.

Preferably, the final search icon pack is information to be selectively output on the screen by the user with being contained in a separate output window or to be removed from the screen by the user.

Preferably, the final search icon pack is configured to be edited by the selection of the user.

Preferably, the search icon pack edition units 26 and 28 include a basic search icon pack edition unit 26 and a final search icon pack edition unit 28.

Preferably, the search icon pack storage units 36 and 38 include a basic search icon pack storage unit 36 and a final search icon pack storage unit 38.

Preferably, the user terminal 2 further includes a search web page storage unit 32 configured to store a search web page which is search result information.

Preferably, the controller 56 operates so as to break the connection with the user terminal 2 at the time when the search icon pack is downloaded to the user terminal 2.

According to another aspect of the present invention, there is provided a control method of a customized search icon output control system, including: a first step of transmitting, by applications embedded in a user terminal 2, a search key word input by a user and user identification information to a customized search support server 20; a second step of extracting, by the customized search support server 20, a search icon pack matched with the search keyword; a third step of transmitting, by the customized search support server 20, the search icon pack to the user terminal 2 and releasing a connection; a fourth step of sequentially executing, by the user terminal 2, the received search icon pack while offline; a fifth step of receiving, by the user terminal 2, a selection signal for a final search icon to connect to the customized search support server 20 so as to transmit search request information thereto; a sixth step of driving a search engine, by the customized search support server 20, using the search request information; and a seventh step of transmitting, by the customized search support server 20, the search result to the user terminal 2.

Preferably, the fourth step is a step of selecting, by search icons of each lower group matched with each search icon of an upper group, each search icon of a multi-stage search icon group having a tree structure.

Preferably, the fourth step is a step of guiding a selection of the search keyword.

Preferably, the search request information in the fifth step is information including all the search icon selection information selected by the user among the search icon packs interworking with the search key words, and the user identification information.

Preferably, the sixth step repeatedly performs: a step of sequentially inputting, by the customized search support server 20, the search icons to the search engine in a selected order to derive the searched result; and a step of applying the subsequent sequential search icon to the derived search result to derive another search result until all the search keywords are applied.

### Advantageous Effects

According to the present invention, the customized search icon output control system and the method thereof may guide users who have difficulties in inputting the search keywords through the search icons of the lower group interworking with the upper group, to easily select the search keywords and may execute the process of selecting the search icons while offline, thereby there is no communication traffic.

### DESCRIPTION OF DRAWINGS

FIG. 1 is a diagram for describing a search structure based on search icons of a customized search icon output control system according to an embodiment of the present invention.

FIG. 2 is a block diagram illustrating a configuration of search icon execution applications of a user terminal included in the customized search icon output control system according to the embodiment of the present invention.

FIG. 3 is a block diagram illustrating a configuration of a customized search support server included in the customized search icon output control system according to the embodiment of the present invention.

FIG. 4 is a diagram illustrating search icon edition states for each user using the customized search icon output control system according to the embodiment of the present invention.

FIG. 5 is a diagram illustrating a structure of providing standard search icon packs for each area and age using the customized search icon output control system according to the embodiment of the present invention.

FIG. 6 is a diagram illustrating a use state of a search icon pack using the customized search icon output control system according to the embodiment of the present invention.

FIG. 7 is a diagram illustrating an appearance state of a final search icon pack using the customized search icon output control system according to the embodiment of the present invention.

### BEST MODE

Hereinafter, the present invention will be described in detail with reference to the accompanying drawings.

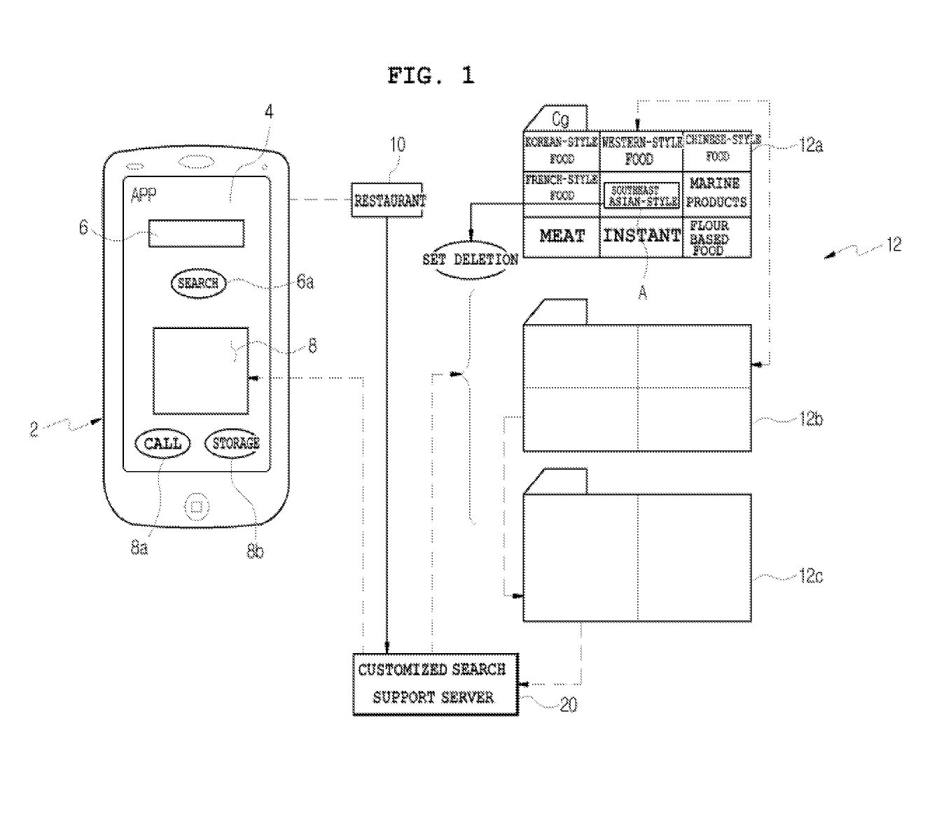

FIG. 1 is a diagram for describing a search structure using a search icon of a customized search icon output control system according to an embodiment of the present invention.

Referring to FIG. 1, the customized search icon output control system according to the embodiment of the present invention is a system for inputting a single search word and sequentially selecting search icons several times to guide a search word selection, to thereby allow a user who has difficulty in selecting proper search words and a user who tries an Internet search while walking to very conveniently use the search word and breaking a connection with a search server while the user selects a search icon using search icon packs downloaded for each search word, to thereby remarkably reduce access traffic.

In detail, the customized search icon output control system according to the embodiment of the present invention is a system that allows a user to search a narrow category of search words from a wide category of search words by himself/herself to perform a search guide, and does not require a communication connection unlike general search engines during performing the search guide to reduce communication traffic.

In more detail, the customized search icon output control system according to the embodiment of the present invention includes a user terminal 2 that has applications embedded therein, and is configured to download search icon packs matched with search keywords input by a user from a customized search support server 20 and perform a search by sequentially selecting the search icon packs; and a customized search support server 20 configured to receive the search keywords from the user terminal 2 to extract the search icon pack matched with the search keywords, break a connection with the user terminal 2, receive search operation information including sequential selection information of the search icon packs from the user terminal 2 to drive a search engine, and transmit the search result to the user terminal 2.

That is, the user terminal 2 has the applications performing a search guide embedded therein, and the applications performs application interface (API) receiving the search icon packs for the search keyword input by the user from the customized search support server 20 and performs the user's search guide. The search guide for the user is performed while the communication connection is broken.

As described above, the search guide guides a user to search the narrow category of search words from the wide category of search words by himself/herself, and therefore provides the search icon in a category type having a tree structure to perform the search guide.

A bundle of a plurality of search icons is referred to as a search icon pack. The search icon pack is received from the customized search support server 20.

The search icon pack is stored in the customized search support server 20 to be matched with each search keyword and is search icon group information which has tree structures connected to each other including first search icon groups 12a that may be selected by the search keyword, and second search icon groups 12b that may be selected by the user among the first search icon groups 12a.

In more detail, as illustrated in FIG. 1, the search icon pack is a package in which the plurality of search icon groups are connected to each other in the tree structure. For example, when a search keyword 10, that is, ‘restaurant’ is input in a search input column 6 output on a main screen 4 of the application embedded in the user terminal 2, and then a search button 6a is clicked, the search guide application transmits the search keyword information of ‘restaurant’ to the customized search support server 20.

Then, the customized search support server 20 extracts the search icon pack matched with the search key information of ‘restaurant’ input by the user from the database and transmits the extracted search icon pack to the user terminal 2. The search icon pack 12 includes first, second, third, . . . and n-th search icon groups 12a, 12b, . . . and 12n which have the tree structure connected to each other.

The customized search support server 20 transmits the search icon pack 12 to the user terminal 2 and cuts off the connection with the user terminal 2.

For example, the first search icon group 12a consists of search icons of ‘Korean-style food,’ ‘Western-style food,’ ‘Chinese-style food,’ ‘French-style food,’ ‘Southeast Asian-style food,’ ‘marine products,’ ‘meat,’ ‘instant,’ ‘flour based food,’ etc., as a first lower group of the search keyword information of ‘restaurant’ input by the user.

Further, when the user selects any one (for example, Korean-style food) of the first search icon groups 12a, the second search icon group 12b may consist of the search icons that more concretes ‘Korean-style food’ as the lower group for the search icon, and may include, for example, ‘Korean Table d'hote,’ ‘Kimichi stew,’ ‘Set menu marinated crab,’ ‘Set menu napa wraps with pork,’ etc.

Similarly, a plurality of search icon groups are included, which have the tree structure connected to each other. In fact, the search guide function is executed so as to allow the user to select the search icon group as a final search word to be searched by the user and access the same.

When the selection of all the search icons is completed, the user may operate the user terminal 2 to transmit the final search icon to the customized search support server 20 and output the result information to an output window 8, and a call button 8a and a storage button 8b are output on the applications in an image form so as to allow the user to call using the result information or store the result information.

In this case, the search icon pack 12 may be stored in the user terminal 2 and the search icon may be deleted by the selection of the user. That is, the search icon pack 12 downloaded by the user is formed in a text to thus have a low capacity, and therefore may be stored in the user terminal 2. When using the search icon pack 12 later, the user may try a deletion edition of the search icons looked upon as being unnecessary for the user so as to more conveniently use the search icon pack 12.

For example, the search icon of ‘Southeast Asian-style food’ may be deleted from the first search icon group 12a. The deleted information is ultimately information that may know tastes of the user, and therefore the applications of the user terminal 2 automatically transmit the deleted information to the customized search support server 20.

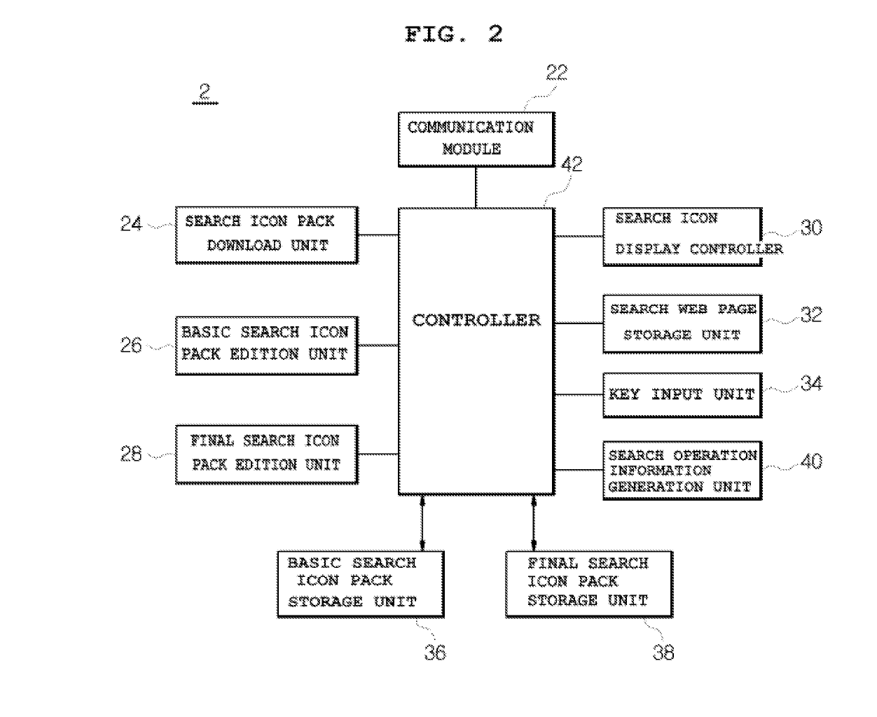

FIG. 2 is a block diagram illustrating a configuration of search icon execution applications of a user terminal included in the customized search icon output control system according to the embodiment of the present invention.

Referring to FIG. 2, the user terminal 2 provided in the customized search icon output control system according to the embodiment of the present invention includes: a communication module 22 which communicates with the customized search support server 20, a search icon pack download unit 24 configured to receive the search icon pack matched with the search keyword input by the user from the customized search support server 20, and search icon pack edition units 26 and 28 configured to allow the user to edit the search icon pack.

Further, the user terminal 2 provided in the customized search icon output control system according to the embodiment of the present invention includes: a search icon display controller 30 which performs a control to display the final search icon on a screen or make the final search icon disappear from the screen by the selection of the user, a key input unit 34 configured to input the search key word and the selection signal of the search icon; a search operation information generation unit 40 configured to combine sequential selection information of the search icon, final search icon selection information, and identification information of the user terminal; search icon pack storage units 36 and 38 configured to store the search icon information; and a controller 42 configured to control each of the components to download the search icon pack including a plurality of search icons to generate the search operation information having sequential selection search icon information of the user and transmit the generated search operation information to the customized search support server 20.

In this case, the search icon pack edition units 26 and 28 include a basic search icon pack edition unit 26 and a final search icon pack edition unit 28.

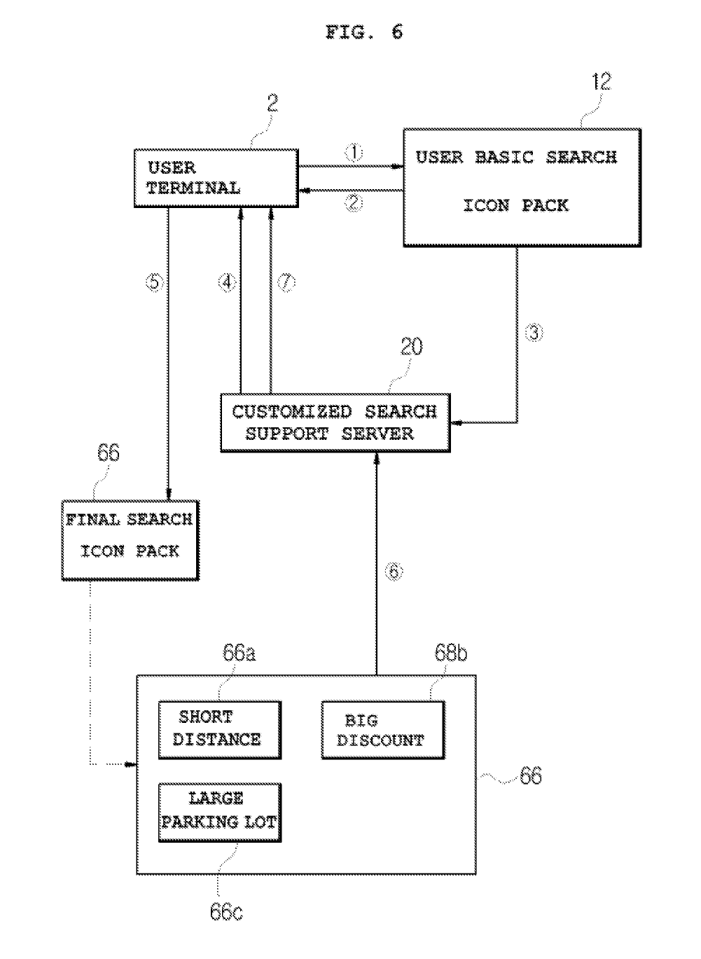

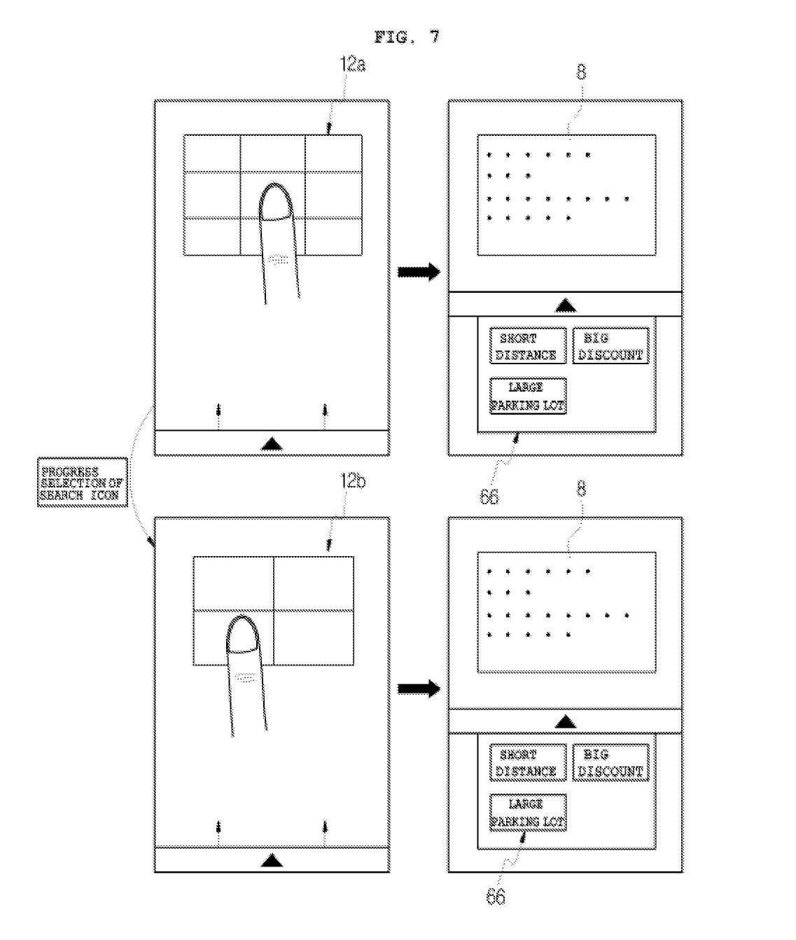

The search icon pack storage units 36 and 38 include a basic search icon pack storage unit 36 and a final search icon pack storage unit 38. The final search icon pack will be described in detail below with reference to FIGS. 6 and 7.

Further, the user terminal 2 further includes a search web page storage unit 32 configured to store a search web page which is the search result information.

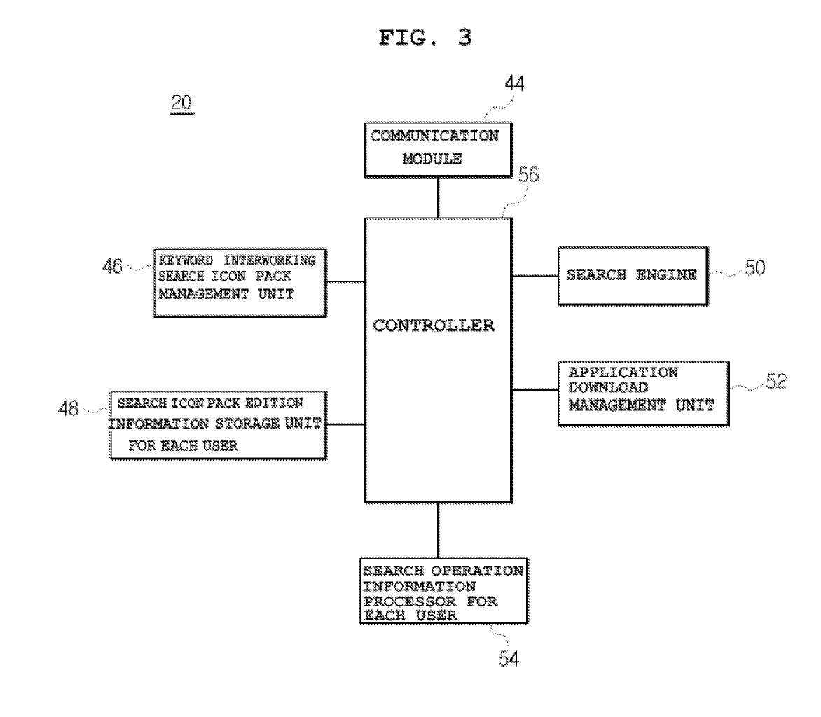

FIG. 3 is a block diagram illustrating a configuration of a customized search support server included in the customized search icon output control system according to the embodiment of the present invention.

Referring to FIG. 3, the customized search support server 20 provided in the customized search icon output control system according to the embodiment of the present invention includes: a communication module 44 which communicates with the user terminal 2; a keyword interworking search icon pack management unit 46 configured to match the search icon packs with each keyword to register and extract the search icon packs; and a pack edition information storage unit 48 configured to receive and store a first search keyword and search icon pack edition information for each user from the user terminal 2.

Further, the customized search support server 20 provided in the customized search icon output control system according to the embodiment of the present invention includes: a search engine 50 configured to perform a search using the search keyword and the icon selection information; an application download management unit 52 configured to manage a search application to be downloaded to the user terminal 2; a search operation information processor 54 for each user configured to sequentially drive the search engine 50 using the sequential search icon information and the final search icon information included in the search operation information received from the user terminal 2; and a controller 56 configured to control each of the components to receive the sequentially selected search icon information from the user terminal 2 so as to drive the search engine.

In this case, the controller 56 operates so as to break the connection with the user terminal 2 at the time when the search icon pack is downloaded to the user terminal 2.

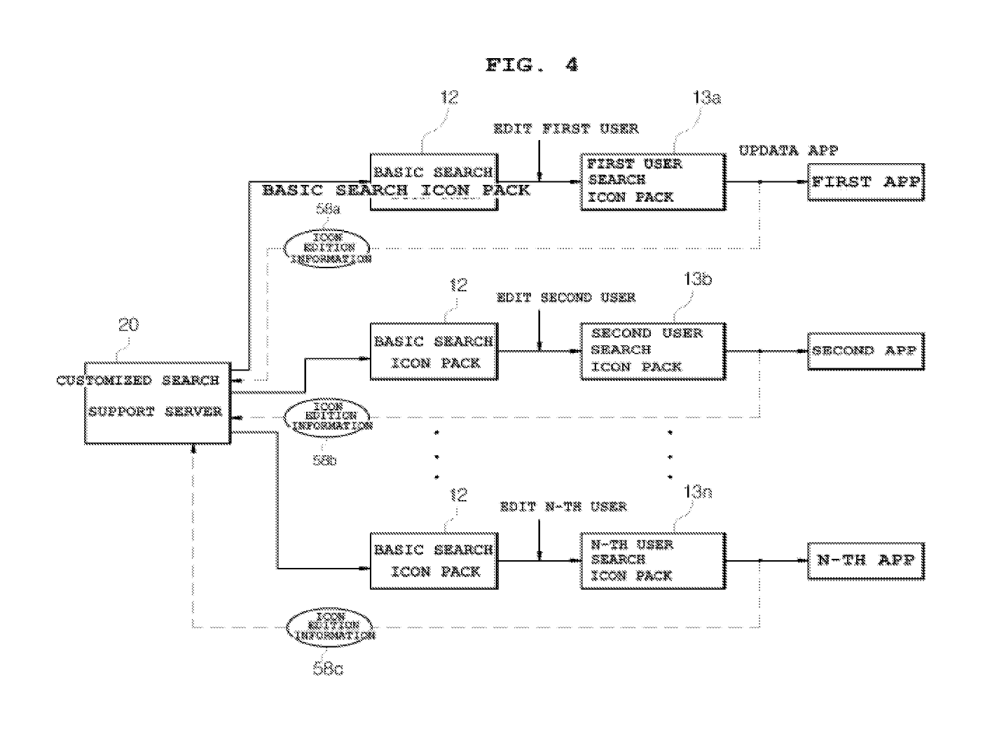

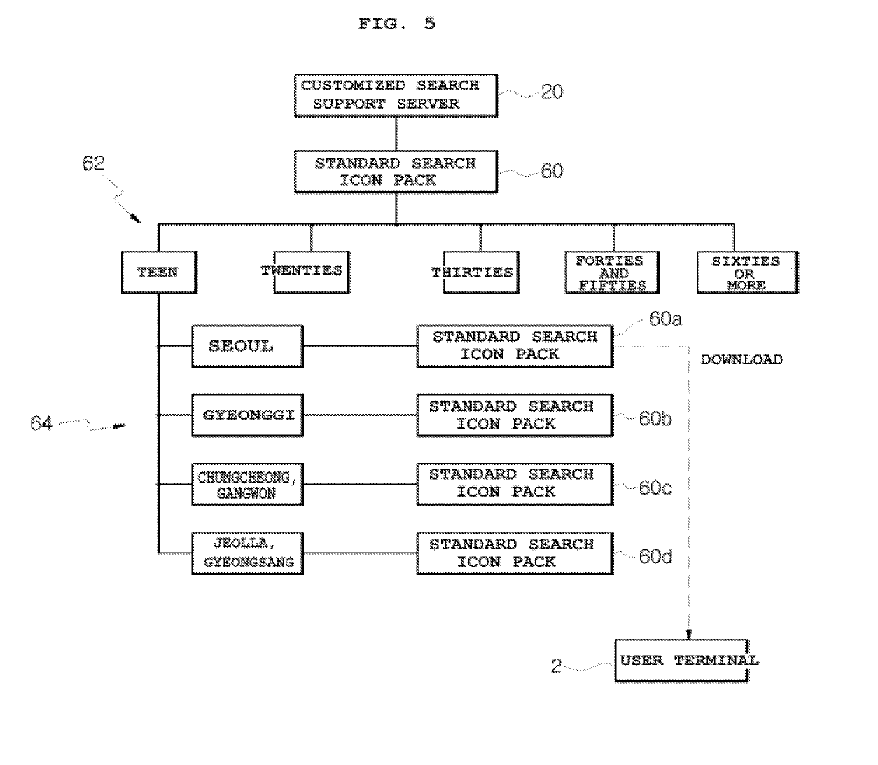

FIG. 4 is a diagram illustrating search icon edition states for each user using the customized search icon output control system according to the embodiment of the present invention, and FIG. 5 is a diagram illustrating a structure of providing standard search icon packs for each area and age using the customized search icon output control system according to the embodiment of the present invention.

Referring to FIGS. 4 and 5, the search icon pack includes basic search icon packs matched with each search keyword and registered in the customized search support server 20, and the standard search icon packs classified for each age and area and downloaded to be stored in the customized search support server 20.

First, when the applications are driven for search, and if the user inputs the search keyword, the applications embedded in the user terminal 2 transmits the search key word input by the user and the user identification information to the customized search support server 20.

Next, as illustrated in FIG. 4, the customized search support server 20 extracts the search icon pack matched with the search key word. Herein, the search icon pack is the basic search icon pack 12.

In this state, the customized search support server 20 transmits the search icon pack to the user terminal 2 and breaks the connection, and the user terminal 2 sequentially executes the received search icon pack while offline.

In more detail, the search icon pack is not automatically executed, rather than, the selection of the search icon is guided in such a manner that, if the user selects any one of the plurality of search icons from the applications, the lower search icon group matched with the search icon is extracted on the screen.

That is, the search icons of each lower group matched with each search icon of the upper group select each search icon of a multi-stage search icon group having the tree structure, and thus the selection of the search key word is guided.

If the selection of the search icon is repeated several times and thus all selections are completed, the user terminal 2 is applied with the selection signal for the final search icon to access the customized search support server 2, thereby transmitting the search request information. As a result, the user terminal 2 access the customized search support server 20, and therefore there is no communication traffic during the process of guiding the search icon.

In this case, the search request information transmitted to the customized search support server 20 by the user terminal 2 is information including all the search icon selection information selected by the user among the search icon packs interworking with the search key words, and the user identification information.

Next, the customized search support server 20 drives the search engine using the search request information, and the customized search support server 20 repeatedly performs a step of sequentially inputting the search icons to the search engine in a selected order to derive the searched result, and a step of applying the subsequent sequential search icon to the derived search result to derive another search result until all the search keywords are applied.

That is, if the user selects ‘Korean-style food’ and ‘Kimchi stew’ using the search icon pack, the user terminal 2 transmits the information on the ‘Korean-style food’ and ‘Kimchi stew’ to the customized search support server 20, and the customized search support server 20 derives the search result matched with the ‘Korean-style food’ identically with the order searched by the user, and derives the search result matched with the ‘Kimchi stew’ to transmit the search result to the user terminal 2.

Further, when the user deletes or edits the specific search icon using the applications during the execution of the search icon pack, the edited search icon packs 13a, . . . and 13n for each user are separately stored in the applications, and icon edition information 58a, . . . and 58n thereof are transmitted to the customized search support server 20 to be used as marketing data.

Further, the customized search support server 20 includes a standard search icon pack 60. The standard search icon pack 60 is a search icon pack for each age and area, which is classified for each age and area and downloaded by the user, thereby making the search guide reflecting ages and areas more convenient.

FIG. 6 is a diagram illustrating a use state of a search icon pack using the customized search icon output control system according to the embodiment of the present invention, and FIG. 7 is a diagram illustrating an appearance state of a final search icon pack using the customized search icon output control system according to the embodiment of the present invention.

Referring to FIGS. 6 and 7, the search icon pack provided in the customized search icon output control system according to the embodiment of the present invention preferably includes the basic search icon packs 12 matched with each search key word, and a final search icon pack 66 which is selection reference information for the final search result regardless of the search keyword.

That is, the user terminal 2 forms the search operation information using the result information obtained by executing the search icon pack. Herein, the search operation information is information including basic search icon selection information, final search selection information, and the identification information of the user terminal.

Preferably, the final search icon pack 66 is information including search icons using a short distance 68a, a business of big discounts 68b, or a business holding a large parking lot 68c as contents.

More preferably, as illustrated in FIG. 7, the final search icon pack 66 is information to be selectively output on the screen by the user with being contained in a separate output window or to be removed from the screen by the user.

That is, the user may push up the final search icon pack 66 with his/her finger to output the final search icon pack 66 on the screen and push down the final search icon pack 68 with his/her finger to make the final search icon pack 68 disappear from the screen.

Similarly, the final search icon pack 66 may be edited by the selection of the user.

Meanwhile, the customized search icon output control system and a method thereof in accordance with the embodiment of the present invention are not limited to the above exemplary embodiments, but may be variously changed without departing from the technical subjects thereof.

1. A customized search icon output control system, comprising:
a user terminal which has applications embedded therein, and is configured to download search icon packs matched with search keywords input by a user from a customized search support server and perform a search by sequentially selecting the search icon packs; and
the customized search support server configured to receive the search keywords from the user terminal to extract the search icon pack matched with the search keywords, break a connection with the user terminal, receive search operation information including sequential selection information of the search icon pack from the user terminal to drive a search engine, and transmit the search result to the user terminal.

2. The customized search icon output control system of claim 1, wherein the search icon pack is stored in the customized search support server to be matched with each search keyword, and includes first search icon groups to be selected by the search keyword and second search icon groups to be selected by the user among the first search icon groups, which are search icon group information having a plurality of tree structures connected to each other.

3. The customized search icon output control system of claim 1, wherein the search icon pack is stored in the user terminal, and the search icon is deleted by a selection of the user.

4. The customized search icon output control system of claim 1, wherein the search icon pack deletes the search icon by a selection of the user and applications of the user terminal automatically transmit the deleted information to the customized search support server.

5. The customized search icon output control system of claim 1, wherein the search icon pack includes basic search icon packs matched with each search key word, and a final search icon pack which is selection reference information for a final search result regardless of the search keyword.

6. The customized search icon output control system of claim 1, wherein the search icon pack includes standard search icon packs classified for each age and area and downloaded to be stored in the customized search support server.

7. The customized search icon output control system of claim 1, wherein the search operation information is information including basic search icon selection information, final search selection information, and identification information of the user terminal.

8. The customized search icon output control system of claim 1, wherein the user terminal comprises:
a communication module which communicates with the customized search support server;
a search icon pack download unit configured to receive the search icon pack matched with the search keyword input by the user from the customized search support server;
search icon pack edition units and configured to allow the user to edit the search icon pack;
a search icon display controller which performs a control to display the final search icon on a screen or make the final search icon disappear from the screen by the selection of the user;
a key input unit configured to input the search key word and the selection signal of the search icon;
a search operation information generation unit configured to combine the sequential selection information of the search icon, final search icon selection information, and the identification information of the user terminal;
search icon pack storage units and configured to store the search icon information; and
a controller configured to control each of the components to download the search icon pack including a plurality of search icons to generate the search operation information having sequential selection search icon information of the user and transmit the generated search operation information to the customized search support server.

9. The customized search icon output control system of claim 1, wherein the customized search support server comprises:
a communication module which communicates with the user terminal;
a keyword interworking search icon pack management unit configured to match the search icon packs with each keyword to register and extract the search icon packs;
a pack edition information storage unit configured to receive and store a first search keyword and search icon pack edition information for each user from the user terminal;
a search engine configured to perform a search using the search keyword and the icon selection information;
an application download management unit configured to manage a search application to be downloaded to the user terminal;
a search operation information processor for each user configured to sequentially drive the search engine 50 using the sequential search icon information and the final search icon information included in the search operation information received from the user terminal; and
a controller configured to control each of the components to receive the sequentially selected search icon information from the user terminal so as to drive the search engine.

10. The customized search icon output control system of claim 5, wherein the final search icon pack is information including search icons using a short distance, a business of big discounts, or a business holding a large parking lot as contents.

11. customized search icon output control system of claim 5, wherein the final search icon pack is information to be selectively output on the screen by the user with being contained in a separate output window or to be removed from the screen by the user.

12. The customized search icon output control system of claim 5, wherein the final search icon pack is configured to be edited by the selection of the user.

13. The customized search icon output control system of claim 8, wherein the search icon pack edition units and include a basic search icon pack edition unit and a final search icon pack edition unit.

14. The customized search icon output control system of claim 8, wherein the search icon pack storage units and include a basic search icon pack storage unit and a final search icon pack storage unit.

15. customized search icon output control system of claim 8, wherein the user terminal further includes a search web page storage unit configured to store a search web page which is search result information.

16. The customized search icon output control system of claim 9, wherein the controller operates so as to break the connection with the user terminal at the time when the search icon pack is downloaded to the user terminal.

17. A control method of a customized search icon output control system, comprising:
a first step of transmitting, by applications embedded in a user terminal, a search key word input by a user and user identification information to a customized search support server;
a second step of extracting, by the customized search support server, a search icon pack matched with the search keyword;
a third step of transmitting, by the customized search support server, the search icon pack to the user terminal and releasing a connection;
a fourth step of sequentially executing, by the user terminal, the received search icon pack while offline;
a fifth step of receiving, by the user terminal, a selection signal for a final search icon to connect to the customized search support server so as to transmit search request information thereto;
a sixth step of driving a search engine, by the customized search support server, using the search request information; and
a seventh step of transmitting, by the customized search support server, the search result to the user terminal.

18. The control method of claim 17, wherein the fourth step is a step of selecting, by search icons of each lower group matched with each search icon of an upper group, each search icon of a multi-stage search icon group having a tree structure.

19. The control method of claim 17, wherein the fourth step is a step of guiding a selection of the search keyword.

20. The control method of claim 17, wherein the search request information in the fifth step is information including all the search icon selection information selected by the user among the search icon packs interworking with the search key words, and the user identification information.

21. The control method of claim 17, wherein the sixth step repeatedly performs:
a step of sequentially inputting, by the customized search support server, the search icons to the search engine in a selected order to derive the searched result; and
a step of applying the subsequent sequential search icon to the derived search result to derive another search result until all the search keywords are applied.
